(19) United States
(12) Patent Application Publication
(10) Pub. No.: US 2002/0078720 A1
(43) Pub. Date: Jun. 27, 2002

(54) Padlocks

(76) Inventor: John Russell Watts, South Melbourne (AU)

Correspondence Address: MARSH, FISCHMANN & BREYFOGLE LLP, 3151 SOUTH VAUGHN WAY, SUITE 411, AURORA, CO, 80014, US

(21) Appl. No.: 09/969,507

(22) Filed: Oct. 1, 2001

Related U.S. Application Data
(63) Continuation-in-part of application No. 09/883,131, filed on Jun. 15, 2001.

(30) Foreign Application Priority Data
Jun. 15, 2000 (AU) PQ8166
Jun. 15, 2000 (AU) PQ8160
Aug. 23, 2000 (AU) PQ9602
Feb. 6, 2001 (AU) PR2871
Apr. 27, 2001 (AU) PR4650

(51) Int. Cl. E05B 67/24

(52) U.S. Cl. 70/38 A

(57) ABSTRACT

A padlock is provided, including a coupler between a cam and the barrel of a cylinder to facilitate operable coupling between the cam and the cylinder, the coupler being configurable to provide a Type 1 padlock characterized by an unlocked, open configuration where a short leg of a shackle is free of a casing and a longer leg of the shackle is supported in the casing and the key is removable, and the coupler being configurable to provide a Type 2 padlock characterized by an unlocked, open configuration where the short leg is free of the body, the longer leg is supported in the body casing and the key and barrel cannot be rotated to an undisplaced position to enable key removal.

### CROSS REFERENCES TO RELATED APPLICATIONS

This Application is a Continuation-in-Part of prior-filed U.S. patent application Ser. No. 09/883,131 filed Jun. 15, 2001 entitled “Padlocks” by John Russell Watts, the entire contents of which are incorporated by reference herein as if set forth herein in full, which prior-filed U.S. patent application claims foreign priority benefits under 35 U.S.C. §119(a)-(d) and/or (f) and/or §365(b) of the following foreign patent applications: Australia PQ8166 filed Jun. 15, 2000; Australia PQ8160 filed Jun. 15, 2000; Australia PQ9602 filed Aug. 23, 2000; Australia PR2871 filed Feb. 6, 2001; and Australia PR4650 filed Apr. 27, 2001.

### FIELD OF THE INVENTION

This invention relates to padlocks, cylinder locks and other locks.

In this specification, where a document, act or item of knowledge is referred to or discussed, this reference or discussion is not an admission that the document, act or item of knowledge or any combination thereof was, at the priority date, publicly available, known to the public, part of the common general knowledge or known to be relevant to an attempt to solve any problem with which this specification is concerned.

Padlocks and cylinder locks are well known types of locks. Furthermore, there are many patents and patent applications relating to locks, such as AU 51912/93 and AU 52587/93.

AU 52587/93 describes a padlock having an extra deep recess for a second ball to enable shackle removal. The shackle is specifically described as a conventional shackle having notched locking recesses. The padlock includes a flat between the second locking recess and peripheral recess, as is common. The locking recesses and flat as described and depicted in AU 52587/93 are produced by notching—more correctly called broaching—which is a process quite different from machining. One of the problems associated with this type of padlock is that it is weakened by the amount of material removed during manufacture.

AU 51912/93 relates to a padlock having a float, free movement between the cylinder barrel and cam and an optional part between the barrel and cam to eliminate the float and convert between a Type 1 and Type 2 padlock. Furthermore this padlock has a stop on the barrel to limit its rotation.

The padlocks of both 52587/93 and 51912/93 employ triangular shoulders projecting from the end of the barrel and end of the cam to mate with free movement with each other unless the ‘play-take-up bridge’ is positioned between the two sets of shoulders.

### SUMMARY OF THE INVENTION

According to the invention there is provided a padlock-A padlock, including a shackle having a short leg with a first locking recess and a longer leg having an opposed second locking recess, said second locking recess being connected by a longitudinally elongated recess or flat to a peripheral recess disposed towards the end of the longer leg,

and a casing having a short and a longer recess extending into the casing from a first end surface to accept the short and longer shackle leg respectively, a central recess extending into the casing from an opposed second end surface, said short, longer and central recesses being intersected by a transverse recess extending into the casing from a first side of the casing,

a cylinder having a key operable barrel characterized by an undisplaced position enabling key removal,

two opposed balls supported within the transverse recess; a first ball able to protrude into the short recess and first locking recess and a second ball to protrude into the longer recess and second locking recess,

a cam to control the balls, a coupler between the cam and the barrel to facilitate operable coupling between the cam and the cylinder,

the coupler being configurable to provide a Type 1 padlock characterized by an unlocked, open configuration where short leg is free of the casing, the longer leg is supported in the casing and the key is removable,

the coupler being configurable to provide a Type 2 padlock characterized by an unlocked, open configuration where the short leg is free of the body, the longer leg is supported in the body casing and the key and barrel cannot be rotated to the undisplaced position to enable key removal.

According to the invention there is further provided a padlock, including a shackle having a short leg with a first locking recess and a longer leg having an opposed second locking recess, said second locking recess being connected by a longitudinally elongated recess or flat to a peripheral recess disposed towards the end of the longer leg,

and a casing having a short and a longer recess extending into the casing from a first end surface to accept the short and longer shackle leg respectively, a central recess extending into the casing from an opposed second end surface, said short, longer and central recesses being intersected by a transverse recess extending into the casing from a first side of the casing,

a cylinder having a key operable barrel characterized by an undisplaced position enabling key removal,

two opposed balls supported within the transverse recess; a first ball able to protrude into the short recess and first locking recess and a second ball to protrude into the longer recess and second locking recess

a cam to control the balls,

the angular disposition of the cam in the locking and unlocking configurations being determined by a stop comprising a disc-like member supported coaxially with and relative to the cam, and being angularly displaceable relative to the cam, being displaceable between a first operative configuration and a second operative configuration,

the padlock being characterized by:

a locked configuration corresponding to the stop being in the first operative configuration, and the cam being in a locking configuration retaining the first ball partly within the first locking recess and the second ball being partly within the second locking recess,

the cam and stop member being rotateable in an unlocking direction by the cylinder to displace the padlock to an unlocked configuration, and

an open, unlocked configuration corresponding to the stop being in the second operative configuration, the short leg being free of the casing, the longer leg being supported in the casing, the cam being in an unlocking configuration retaining the second ball partly within the longitudinally elongated recess or flat or partly within the peripheral recess.

The shackle of the present invention differs in many respects from padlocks such as those described in prior art document AU 51912/93 including the fact that the present invention is stronger because less material need be removed during manufacture of the padlock of the present invention

Furthermore, the padlock of the present invention differs from padlocks such as those described in AU 52587/93 because the present invention only requires reconfiguration of a coupler to convert between Type 1 and Type 2 padlocks. The present invention does not limit the rotation of the barrel and therefore is applicable to interchangeable core where commonly the barrel is unrestrained.

Preferably, the cam includes a first cam portion comprising a substantially cylindrical portion having a curved side surface defined by a longitudinal axis coaxial with the cam axis of rotation and which is parallel with and between the longitudinal axii of the short and longer recess in the casing,

said cam in a locking configuration presenting the curved surface to each ball to retain the balls in the locking recesses,

said cam in the unlocking configuration presenting a first unlocking recess to the first ball and a second unlocking recess to the second ball to enable the first ball to be removed from the first locking recess and the second ball to be displaced from the second locking recess to become partly within the longitudinally elongated recess or the flat or partly within the peripheral recess.

Preferably the first cam portion is integrally connected to a cam drive portion comprising at least one and preferably two opposed drive recesses, each said drive recess having a floor defined by a plane orthogonal to the axis of rotation of the cam and a side wall, each said drive recess being radially displaced from the cam axis of rotation,

and a bridge portion defined in part by the side wall/walls of each drive recess, each said side wall having a first engageable drive shoulder at one end and a second engageable drive shoulder at the other end, said bridge having opposed peripheral end walls comprising cylindrical portions to support a disc-like stop member which has an aperture of substantially circular cross-section interrupted by one and preferably two fingers according to the number of drive recesses, each said finger inwardly protruding into a separate drive recess to be engageable with a first drive shoulder of the respective side wall and wherein each finger abuts a first drive shoulder when the cam is in the unlocking configuration.

Preferably, the padlock when configured as a Type 1 padlock, includes a coupler comprising at least one drive pin supported within the cylinder barrel each said drive pin extending into the space between the finger and second drive shoulder to be engageable with the finger, to enable the drive pin to be displaced about the cylinder barrel axis of rotation to displace the first drive shoulder and the interposed finger to the unlocking configuration, and the barrel and key to subsequently be returned to the undisplaced position while the drive pin correspondingly displaces freely within the space between the at least one finger and second drive shoulder.

Preferably in the padlock configured as a Type 1 padlock, there is an opposed pair of fingers, an opposed pair of drive shoulders, opposed drive recesses with pin holes and there is correspondingly an opposed pair of drive pins,

said drive pins having passage through while being supported in a support disc to comprise a coupler subassembly, the drive pins being configured to protrude more from one side of the support disc than the other and additionally being configured so that when assembled into the padlock body with the shorter ends towards the cam, they protrude into drive recesses but not into the pin holes.

Preferably, the padlock when configured as a Type 2 padlock, includes a coupler comprising at least one drive pin supported within the cylinder barrel each said drive pin extending through the space between the finger and second drive shoulder to protrude into a pin recess within the floor of the drive recess and adjacent the finger, to enable the drive pin to be displaced about the cylinder barrel axis of rotation to displace the first drive shoulder and the interposed finger to the unlocking configuration, the barrel and key being unable to be returned to the undisplaced position because of the direct coupling between the drive pin and cam.

Preferably, in the padlock when configured as a Type 2 padlock, there is an opposed pair of fingers, an opposed pair of drive shoulders, opposed drive recesses with pin holes and there is correspondingly an opposed pair of drive pins,

said drive pins having passage through while being supported in a support disc to comprise a coupler subassembly, the drive pins being configured to protrude more from one side of the support disc than the other and additionally being configured so that when assembled into the padlock body with the longer ends towards the cam, they protrude into the pin holes.

Preferably, the first cam portion has a removal configuration enabling the removal of the shackle, the cam in the removal configuration presenting a third side recess, deeper than the second recess, to the second ball to enable the second ball to be removed from all the recesses of the longer leg,

and wherein the cam is rotatable in the unlocking direction to the removal configuration while the stop remains in the second operative configuration, said removal configuration corresponding to the short leg being free of the casing.

Preferably each finger in the removal configuration of the cam abuts an associated stop shoulder.

Preferably the padlock includes a torsion spring supported about the bridge having one end attached to the cam and the other within the offset recess to bias the cam towards the locking configuration

Preferably, the padlock includes a compression spring within the longer recess to bias the shackle from the body.

Preferably, the cylinder is removable to provide accessibility to the cam to enable it to be rotated to the removal configuration while the stop remains undisplaced in the second operative position.

In a preferred embodiment, the cylinder is retained in the casing by a threaded fastener having a head accessible through the short recess, said cylinder barrel being free to rotate without limitation when the cylinder is removed from the casing.

In a preferred embodiment, the cylinder comprises an interchangeable core retained in the casing by a sideways protruding shoulder that is displaceable to withdraw into the core by the application of a control key, said cylinder barrel being free to rotate without limitation when the cylinder is removed from the casing.

Preferably, the cylinder comprises a pin cylinder having a casing with pin chambers extending from the surface of the casing, and wherein adjacent chambers adjacent the surface of the casing are joined by a channel, said channel accommodating a resilient elongated strip extending between the chambers and having substantially cylindrical portions extending one into each chamber.

According to the invention there is provided a padlock substantially as described herein with reference to and as illustrated in the accompanying drawings.

According to the invention there is provided padlock shackle having at least one locking recess having a surface substantially comprised of portions of surfaces of revolution, each portion having an axis of revolution which intersects the general form of the shackle to provide a surface portion extending on all sides from the axis of revolution.

Preferably the shackle includes a locking recess comprising two such portions located adjacently and a small distance from an other recess each being joined by a channel portion.

Preferably the shackle is defined by two parallel co-planar legs; a short leg having a first locking recess and a longer leg having a second locking, substantially opposed, recess; the second locking recess being connected by a longitudinally elongated recess to a peripheral recess disposed towards the end of the longer leg,

the surface of the first and second locking recesses being substantially comprised of portions of surfaces of revolution, each portion having an axis of revolution which intersects the general form of the shackle to provide a surface portion extending on all sides from the axis of revolution.

Preferably, the longitudinally elongated recess comprises a longitudinal channel of substantially uniform cross-section

Preferably, the peripheral recess comprises a peripheral channel around the periphery of the shackle body of substantially uniform cross-section.

Preferably, the portions of surfaces of revolution comprise spherical portions defined by a radius substantially the same as the radii of the balls.

Preferably the channel cross-section is defined by a radius substantially the same as the radii of the balls.

Preferably, the channel cross-section is defined by a radius substantially the same as the radii of the balls.

According to the invention there is further provided a padlock shackle substantially as described herein with reference to and as illustrated in the accompanying drawings.

According to the invention there is further provided a padlock having a preferred padlock shackle

According to the invention there is provided method of manufacture of a padlock shackle including advancing a rotating cutter blade into the side of an unformed shackle blank to manufacture a recess.

Preferably the method includes advancing a rotating cutter blade into the side of an unformed shackle blank and then advancing it longitudinally along the shackle body to manufacture a channel.

Preferably the method includes manufacturing a first and then a second locking recess by advancing a rotating cutter blade into the side of an unformed shackle blank and then partly withdrawing the cutter from the second locking recess and then advancing it longitudinally along the shackle blank to manufacture a channel, said longitudinal channel connecting to a pre-manufactured peripheral recess

Preferably the method includes aligning the shackle blank so that the plane in which the axii of the spherical portions lie is orthogonal to the longitudinal axis of a mandrel, fixing a leg portion of the shackle blank within an elongated recess in a substantially tangential extension to the mandrel which includes an operating lever such that a reference portion of the shackle blank is retained adjacent to a cylindrical portion of the mandrel with the recesses disposed generally towards the mandrel, said reference portion comprising the junction between a leg and joining portion,

Positioning a roller adjacent the reference portion so that the shackle blank extends tangentially in relation to and from between the mandrel and roller, rotating the mandrel while maintaining the roller undisplaced to form the shackle blank into a shape corresponding to the mandrel to form the shackle body portion which joins the short and longer legs and to align the legs so that the longitudinal axii of the legs are substantially parallel.

Preferably the method includes surfaces of the roller and cylindrical portion of the mandrel, where they contact the shackle blank, comprise annular recesses having a semi-circular cross-section defined by a radius substantial the same as the radius of the shackle body.

Preferably the method includes the axis of the cutter being within a plane that intersects the longitudinal axis of the shackle blank.

### DESCRIPTION OF THE DRAWINGS

Embodiments of the present invention will now be described by way of example only with reference to the accompanying drawings in which:

FIG. 1 is a schematic side view of a padlock with the shackle removed,

FIG. 2 is a schematic partial sectional view AA of the padlock of FIG. 1,

FIG. 3 is a schematic partial sectional view BB of the padlock of FIG. 1

FIG. 4 is a partly cut-away isometric view of the padlock of FIG. 1

FIG. 5 is an exploded, isometric view, looking from above, of the cam and adjacent components,

FIG. 6 is an exploded, isometric view, looking from below, of the cam and adjacent components,

FIG. 7 is an isometric view looking from below, of the cam and drive pins when configured for a Type 1 padlock,

FIG. 8 is an isometric view looking from below, of the cam and drive pins when configured for a Type 2 padlock,

FIG. 9 is a schematic side view of an unlocked, open padlock,

FIG. 10 is a schematic partial sectional view AA of the padlock of FIG. 9,

FIG. 11 is a schematic partial sectional view BB of the padlock of FIG. 9,

FIG. 12 is a partly cut away isometric view of the padlock of FIG. 9,

FIG. 13 is a schematic side view of a locked, closed padlock,

FIG. 14 is a schematic partial sectional view AA of the padlock of FIG. 13,

FIG. 15 is a schematic partial sectional view the padlock of FIG. 13,

FIG. 16 is a partly cut away isometric padlock of FIG. 13,

FIG. 17 are isometric views of the showing the first locking recess and the second locking recess and the and peripheral recesses,

FIG. 18 is a sectional view defined by a plane that intersects the longitudinal axis of the shackle,

FIG. 19 is a schematic side view of a padlock employing a removable cylinder

FIG. 20 is a partly cut-away, exploded, isometric view looking from above, of the padlock of FIG. 19,

FIG. 21 is a schematic side view of a padlock employing an interchangeable core,

FIG. 22 is a partly cut-away exploded, isometric view looking from above, of the padlock of FIG. 21,

FIG. 23 is a schematic side view of a cutting tool and shackle blank,

FIG. 24 is a schematic, isometric view of the shackle blank being formed,

FIG. 25 is an exploded, isometric view of alternative drive pins and an alternative pin-holder

### DESCRIPTION OF THE PREFERRED EMBODIMENTS

The invention provides improvements in padlocks including improvements in padlock shackles, cams and cylinders, and means for manufacturing padlocks including means for manufacturing shackles, cams and cylinders.

It is envisaged that elements of the invention, including the improved cam, shackle and cylinder, be transported in other locking devices.

Improvements in padlocks reference two types of padlocks; a Type 1 padlock that may be opened while having the key removed from the cylinder; and a Type 2 padlock where the key cannot be removed unless the shackle is closed.

In preferred embodiments, the padlock can be converted between a Type 1 padlock and a Type 2 padlock by simply re-configuring components while in other preferred embodiments, the padlock can be converted between a Type 1 padlock and a Type 2 by simply re-orientating a removable sub-assembly, without the need for special tools and without additional parts.

In preferred embodiments, the padlock employs a removable cylinder retained by a removable screw, while in other embodiments, the padlock employs what is commonly called an interchangeable core that is removable by the application of a control key.

In preferred embodiments the padlock employs a shackle of well-known design comprising a pair of substantially parallel substantially cylindrical legs, one short leg and one longer leg, connected together by a connecting portion preferably comprising part of a torus. Towards the free end of the short leg and facing the longer leg is a first locking recess and directly opposite in the longer leg and facing the short leg is a second locking recess. Towards the free end of the longer leg is a peripheral recess that is connected to the second locking recess by a longitudinally elongated flat. The locking recesses and flat comprise scallops in the side of the shackle body manufactured by broaching the shackle body from the side after the shackle body has been formed into the generally horse-shoe shape.

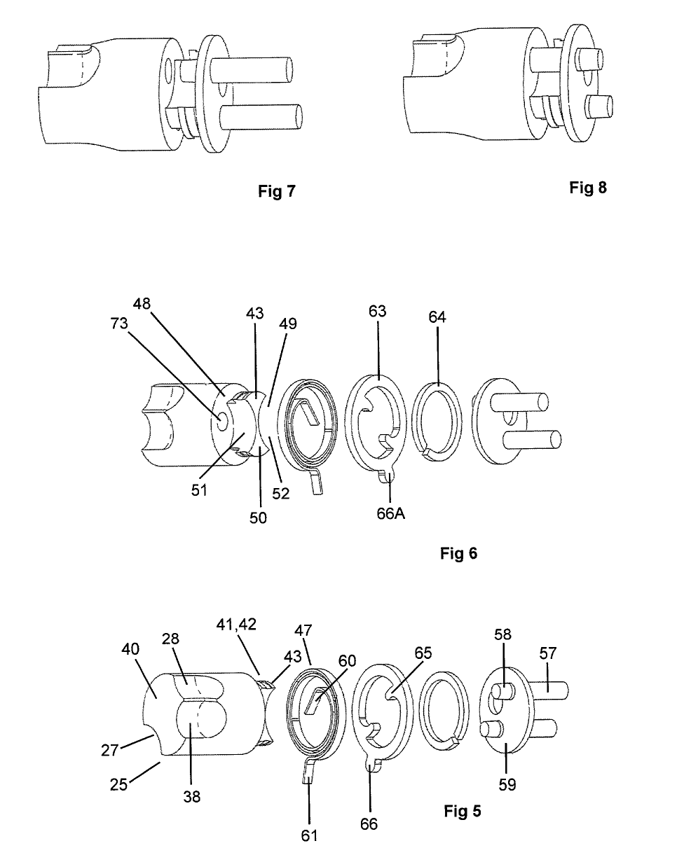

In other preferred embodiments, the padlock employs a shackle 1 of improved, as shown in FIG. 4, 17 and 18, comprising a pair of substantially parallel substantially cylindrical legs—one short leg 2 and one longer leg 3, connected together by a connecting portion 4 preferably comprising part of a torus. Towards the free end of the short leg 2 and facing the longer leg is a first locking recess 6 and directly opposite in the longer leg and facing the short leg 2 is a second locking recess 7. Towards the free end of the longer leg is a peripheral recess 8 that is connected to the second locking recess by a longitudinally longitudinally elongated channel 10.

FIG. 18 shows the preferred shackle, said shackle being partly defined by a central plane that passes through the longitudinal axis of the legs and the sectional view in FIG. 18 is defined by this central plane. With reference to this sectional view, one can see that the peripheral recess at the deepest point 11 and the channel at the deepest point 12 are substantially the same depth from the inside edge of the sectioned longer shackle leg and a lesser depth than the second locking recess at the deepest point 14, the locking recesses being described in more detail below.

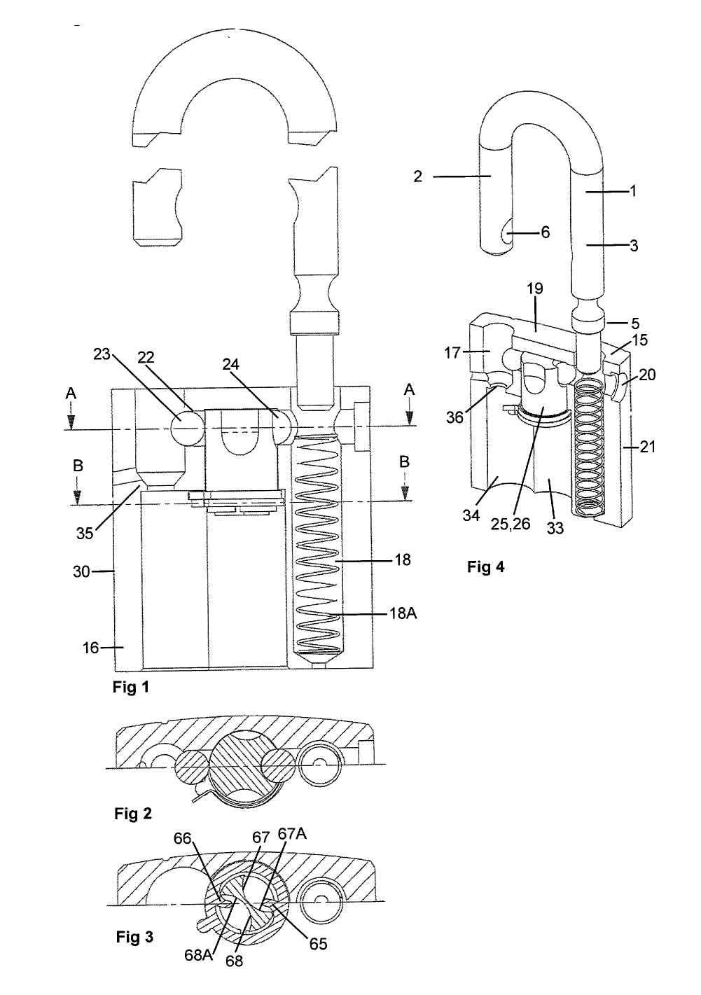

In preferred embodiments of the padlock, as shown in FIG. 1 to 4, the padlock includes a body 15, including a casing 16 having a short recess 17 extending into the casing from a first end surface 19 to receive the short shackle leg 2 and a longer recess 18 extending into the casing from the first end surface 19 to receive the longer shackle leg 3, and a transverse recess 20 in the vicinity of the first end surface 19 commencing at a first side surface 21 of the body and intersecting the deep and short recess and in the region of the short recess having a constriction 22 of reduced cross-section so a first locking ball 23 described below, cannot pass from the transverse recess 20 into the short recess 17. Preferably the axis of the cross recess 20 orthogonally intersects the axii of the short and deep recesses 17 and 18 which are preferably parallel and substantially cylindrical if form, said recesses being preferably formed by a rotating cutter tool that is advanced into the padlock casing from the first end surface 19.

The padlock is configured such that in a locked configuration, the short leg 2 including the first locking recess 6 is within the short recess 17 and the longer leg 3 including the second locking recess 7 is within the longer recess 18 and additionally, the locking recesses 6 and 7 are substantially aligned with the transverse recess 20. Preferably, in the locked configuration, the deepest point 14 of the second locking recess 14 is substantially co-axial with the axis of the cross-recess.

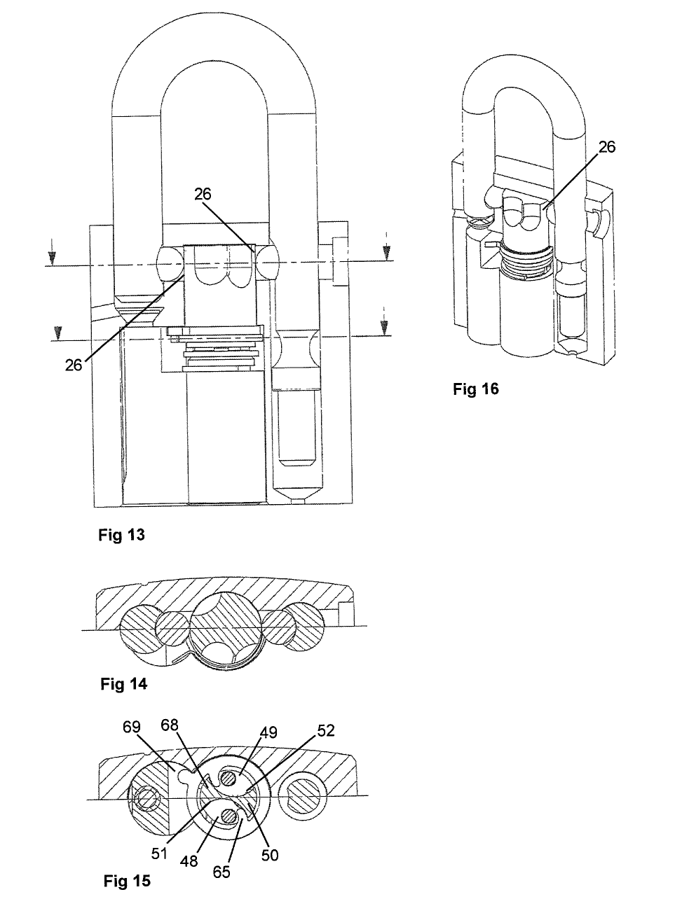

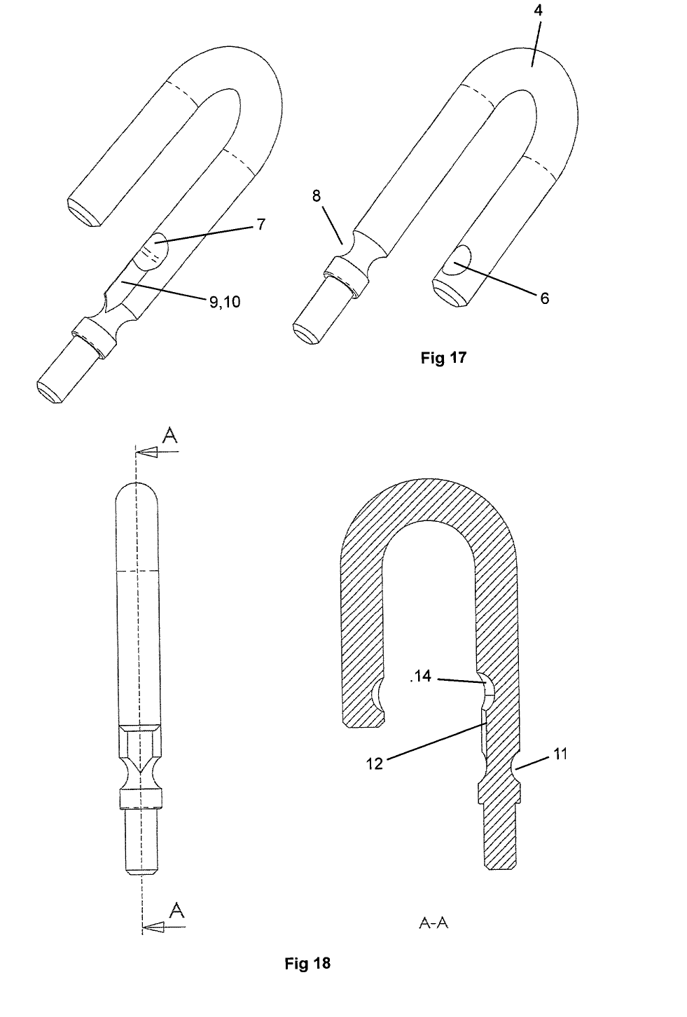

In the locked configuration, FIG. 13 to 16, the first ball 23 locates partly within the first locking recess 6 and partly in the transverse recess 20 and a second locking ball 24 locates partly in the second locking recess 7 and partly within the cross recess 20. Between the balls is a displaceable, (preferably angularly displaceable), cam 25 of varying cross-section. In the locked configuration, the balls abut a side surface 26 of the cam, this engagement preventing the balls from moving inwardly to release the shackle legs.

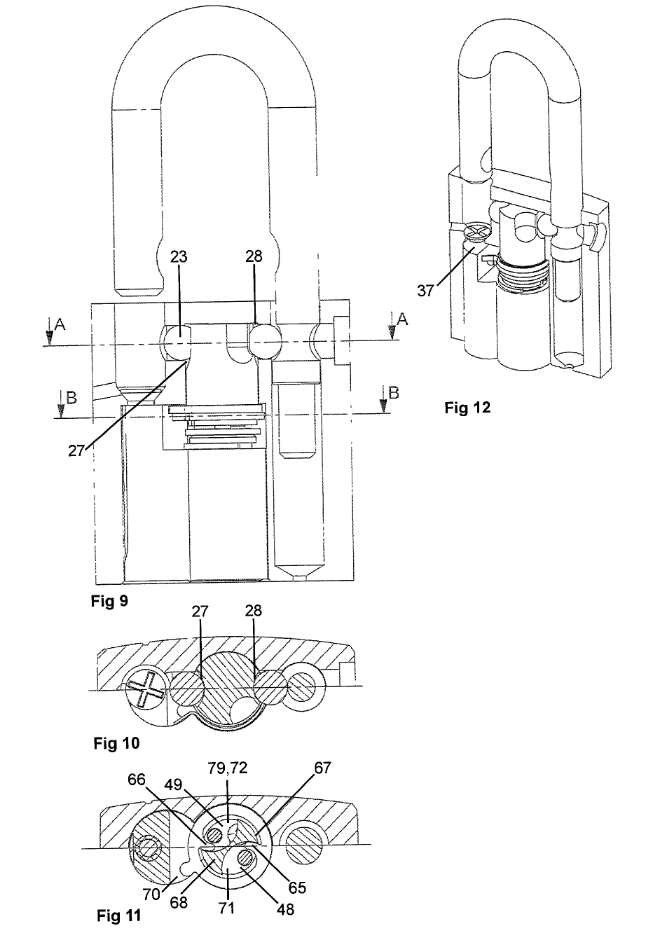

When the cam is in the unlocked configuration, as shown in FIG. 9 to 12, the first ball 23 is partly within a first unlocking recess 27 of the cam and completely withdrawn from the first locking recess 6 in the short leg to thereby release the short leg.

Opposite this first unlocking recess 27 is a similar, second unlocking recess 28. When the cam is in the unlocked configuration and the short leg is released from the body, the second ball is partly within the second unlocking recess 28 and partly within the peripheral recess or partly within the flat or channel 10, depending on the shackle configuration. When the second ball is retained in this flat or channel the shackle may be moved relative to the casing. When the second ball 24 is in the second unlocking recess 28 and partly within the peripheral recess11, the shackle can be rotated in relation to the body while being retained in the body.

The casing is defined by a first end surface 19 referred to above, an opposed second end surface 29, a first side surface 21 referred to above, an opposed second side surface 30, a front surface 31 and a back surface 32.

Coaxial with the axis of rotation of the cam is a central recess 33 that extends into the casing from the second end surface 29 to provide a recess to support the cam while accommodating a cylinder barrel; this central recess being intersected by the transverse recess. In a preferred embodiment employing a removable cylinder there is adjacent to the central recess 33, an offset recess 34 of lesser depth, having a longitudinal axis parallel to that of the central recess and displaced sideways from that of the central recess such that this recess is intercepted by the axis of the short recess 7. The offset recess has a depth not so great as to intersect recess 17 by which it is separated by a bridge portion 35. The central recess and offset recess preferably each comprise cylindrical recesses having axii parallel to those of the recesses 17 and 18 to together form a chamber of a generally FIG. 8 cross-section to accommodate a cylinder of similar cross-section. In some preferred embodiments, the central recess comprises a first substantially cylindrical portion joined to a coaxial substantially cylindrical second portion of smaller diameter, said second portion supporting the cam while being intersected by the transverse recess.

Alternatively, the offset recess comprises a parallel-sided oval so that together the oval and offset recess form a pear-shaped recess to accommodate a cylinder of common European profile. And alternatively again, the combined recesses have a substantially FIG. 8 cross-section and configured to accept and retain an interchangeable core; in which case the offset recess need not be intercepted by the axis of the short recess 7.

The offset recess extending towards the short recess provides the bridge portion 35 between these recesses 34 and 17. In embodiments not employing an interchangeable core, this bridge portion includes an aperture 36 that extends from the recess 17 to the offset recess 34 to provide passage for a fastener by which the cylinder is fastened into the padlock casing. Preferably the fastener comprises a countersunk headed screw 37 and the recess 17 is adapted by the inclusion of a conical recess to accommodate the screw head; the screw shank passing through the aperture 36 to engage in a threaded recess within an extension to the cylinder to retain the cylinder within the combined recesses. Preferably, the screw is thread-forming and forms a thread in the cylinder when it is inserted, thereby precluding the need for a tapped hole in the cylinder, which otherwise must be provided.

In preferred embodiments, the shackle is easily removed from the body. In these embodiments the cam includes an additional release recess 38, as shown in FIG. 5, similar to the unlocking recesses and having a configuration such that when the second locking ball 24 is partly in the release recess, the second ball is completely withdrawn from the longer shackle, i.e. completely withdrawn from the peripheral recess in the longer leg to thereby release the shackle and enable it to be removed from the body.

In preferred embodiments, the cam 25 includes a first cam portion comprising a substantially cylindrical portion having a curved side surface defined by a longitudinal axis coaxial with the cam axis of rotation, and a substantially circular first end face 40 adjacent to the closed end of the central recess 33 and an opposed second end 41; said axis of rotation being substantially parallel to and between the longitudinal axii of the short and longer recess in the casing,

In preferred embodiments, the first cam portion includes the first unlocking recess 27 and the second unlocking 28 and the release recesses 38. These recesses are disposed within the curved side of the first cam portion and preferably comprise partial cylindrical concave surfaces which extend from the first end face 40 towards the second end 41 and to a depth that provides free movement of the balls into their respective recesses.

Preferably, each of these recesses 27, 28 and 38 is formed by advancing a rotating cutter into the partially made cam from the first end face, said cutter having an axis of rotation parallel with that of the cam axis of rotation and a periphery which overlays the cam. Preferably the diameter of the cutter is substantially the same as the diameter of the locking balls described below.

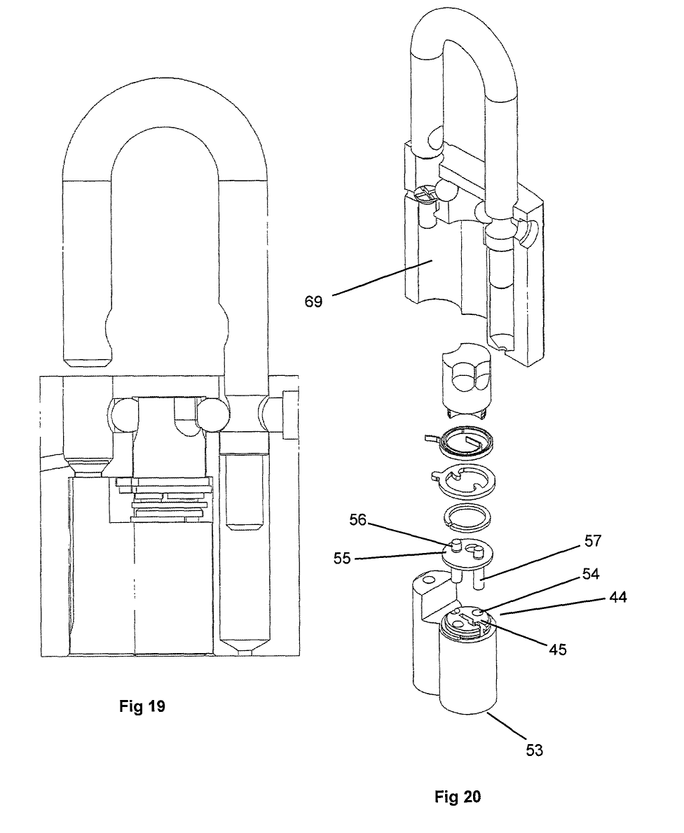

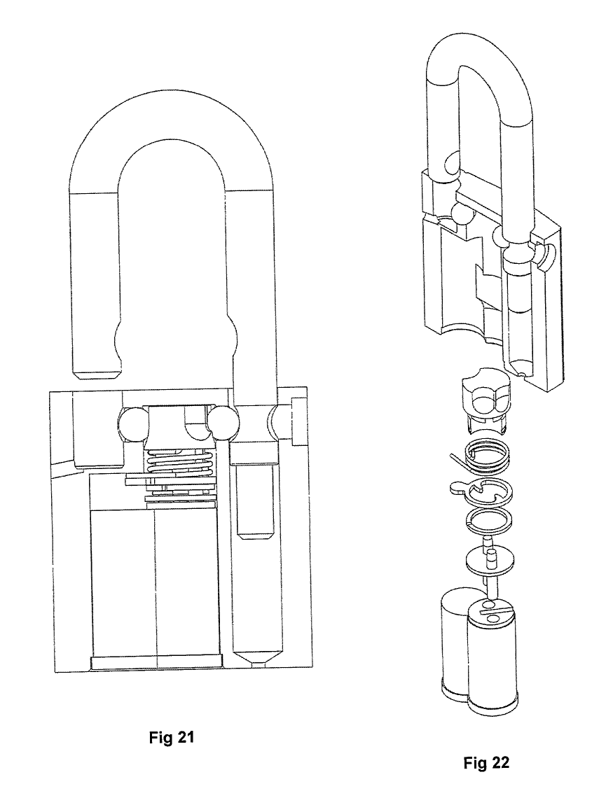

In preferred embodiments, as shown in FIG. 5, the first cam portion is integrally connected to a cam drive portion 42 having a second end face 43 disposed towards the inner end 44 of the cylinder barrel 45 as shown in FIG. 20, said drive portion comprising at least one and preferably two opposed drive recesses 48, 49, each said drive recess having a floor defined by a plane orthogonal to the axis of rotation of the cam and a side wall 51, 52 respectively, each said drive recess being radially displaced from the cam axis of rotation, and a bridge portion defined in part by the side wall/walls of each drive recess, each said side wall 51, 52 having a first engageable drive shoulder respectively at one end and a second stop drive shoulder 67A, 68A , said bridge having opposed peripheral end walls comprising support a disc-like stop member which has an aperture of substantially circular cross-section interrupted by one and preferably two fingers according to the number of drive recesses, each said finger inwardly protruding into a separate drive recess 48, 49 to be engageable with a first drive shoulder of the respective side wall 51, 52 and wherein each finger abuts a first drive shoulder when the cam is in the unlocking configuration.

As shown in FIG. 6, commencing at the floor of each drive recess 48 49, and extending towards the first end surface 40, and having an axis parallel to that of the cam, is an elongated additional pin recess 73, positioned as shown in FIG. 15, such that in the locking configuration of the cam, the axis of each of these recesses 73 is coaxial with an axis of a pin recesses 54 in the barrel when the barrel is in the undisplaced, key removal configuration. Preferably, the diameter of the additional recesses is substantially the same as the diameter as the pin recesses 54.

Preferably, the cam drive portion is substantially cylindrical in form but of reduced cross-sectional diameter so as to accommodate a torsional spring 47,which is supported around the drive portion, within the diameter of the central recess.

Each drive recess is manufactured by advancing a rotating cutter blade into the partly made cam from the second end face 43 towards the first end, said cutter having an axis of rotation parallel with that of the cam and a periphery which overlays the cam.

Projecting from the surface of the inner end 44 of the barrel and towards the key entry end 53 of the barrel, is one and preferably two pin recess 54 each having an axis parallel to that of the barrel. Within each barrel pin recess 54 are longitudinally elongated drive pins 57 that include portions that extend towards the cam.

In a padlock configured as a Type 1 padlock, each drive pin is configured to effect a first coupling mode by extending towards the cam to extend into a drive recesses 48, 49 to longitudinally overlap a respective drive shoulder 51, 52 but not so far as to engage in an additional pin recess 73 in the cam—this arrangement operably coupling with free movement the cam to the barrel.

In a padlock configured as a Type 2 padlock, each drive pins is configured to effect a second coupling mode by extending towards the cam to extend into a drive recesses 48, 49 and to engage in an additional pin recess 73 in the cam—this arrangement operably coupling without free movement the cam to the barrel.

By simply changing the length that each drive pin protrudes into the cam, the padlock can be reconfigured between a Type 1 and Type 2 padlock.

In a preferred embodiment, the coupler comprises at least one, and preferably a pair of drive pins, each projecting one from each pin recess 54 in the barrel. Adjacent to the inner end 44 of the barrel is a disc-like pin-holder 55 having a drive pin aperture 56 coaxial with each drive pin but of small diameter than the diameter of the drive pins, each said drive pin aperture having a parallel sided elongatation so as to extend the recess to the periphery of the disc-like pin-holder. Within the length of each pin is one and preferably multiple annular surface recesses engageable with the pin apertures 56 in the pin-holder such that when a each pins is supported within the pin-holder by an annular recess and these members are supported within a padlock with the pin-holder supported between the barrel and cam, each drive pins is restrained from longitudinally displacing.

In a padlock configured as a Type 1 padlock, each drive pin annular recess engaged with the aperture in the pin-holder is configured such that the portion of the drive pin extending from the pin-holder and disposed towards the cam extends into a separate drive recesses 48, 49 but not so far as to engage in the additional pin recess 73 in the cam.

In a padlock configured as a Type 2 padlock, each drive pin annular recess engaged with the aperture in the pin-holder is configured such that the portion of the drive pin extending from the pin holder and disposed towards the cam extends from the barrel into a drive recesses then further to engage in an additional pin recesses 73 in the cam to directly couple the cam to the barrel without significant free movement.

By simply arranging the length that each drive pin protrudes from the disc-like pin-holder by engaging the appropiate drive pin annular groove within the pin aperture of the disc-like member, the padlock can be reconfigured between a Type 1 and Type 2 padlock. Each recesses within the disc-like member is configured such that when an annular recess is with the plane of the disc-like member, the drive pin can be assembled to the pin holder by radially displacing it from the vicinity of the periphery to be coaxially aligned.

Additionally, this embodiment of the drive pin enables a shorter cylinder to be employed by providing a spacer between the barrel and cam, as shown in FIG. 25. The spacer is provided by a pair of spaced pin-holders assembled within the length of the drive pins; a first disc to be adjacent the interior end of the cylinder barrel 44, a second disc to be adjacent the cam and the drive pins would protrude from the second disc to provide either a Type 1 or Type 2 padlock. Each drive pin would preferably have multiple annular grooves to enable the members to be assembled to provide different padlock types while accommodating different cylinder lengths.

In another preferred embodiment as shown in FIG. 5 to 8 and 20, projecting from the surface of the inner end 44 of the barrel towards the key entry end 53 of the barrel, is one and preferably two, pin recess 54 each having an axis parallel to that of the barrel. Adjacent to the inner end 44 is an alternative disc-like pin-holder 55 having a pin aperture 56 coaxial with each pin recesses 54 but of small diameter. Within the barrel is at least one and preferably two, longitudinally elongated pins 57, each pin having passage through the pin-holder 55 to comprise a pin extension 58 which extends from the pin-holder 55 towards the cam. Preferably, at the point of intersection with the member 55 each pin reduces in diameter to the diameter of the aperture 56 to be restrained by member 55 from displacing towards the cam. In a preferred embodiment, each pin 57 and member 55 comprise a separate subassembly 59, which is inserted into the barrel as one. The pin extension is a shorter length than the balance of the pin by a given distance.

In a first coupling mode, each drive pin extension extends towards the cam to extend into a separate drive recess 48, 49 to longitudinally overlap a respective drive shoulders 51 and 52—this arrangement operably coupling with free movement the cam to the barrel so that the barrel may be turned to angularly displace the cam. Preferably there is a pair of pins disposed diagonally opposite one on each side of the keyway in the barrel.

The cam torsion spring 47, surrounding the drive portion of the cam has a moveable end 60 held in one of the drive recesses to abut a portion of the associated drive shoulder and a fixed end 61 projecting into the offset recess to abut a portion of the offset recess wall. It is configured to bias the cam away from the unlocked configuration and towards the locked configuration. Alternatively, the end 60 comprises a spring return which extends are short distance in a direction parallel to the axis of the cam to mate in a recess commencing at the floor of a drive recess and extending towards the first end surface.

A stop means is included in the cam assembly to control cam rotation and among other things, to prevent the cam from being rotated by the spring in a clockwide direction from the locked configuration, and also to restrain the cam from being rotated by the barrel in an anticlockwise direction from the unlocking configuration. Preferably, the stop means comprises a substantially annular member 63 that straddles the bridge 50 to be supported by the bridge to be angularly displaceable relative to the bridge.

Preferably the cam comprises a sub-assembly of components where the spring is retained between the first cam portion of larger diameter and the stop member 63 that is itself retained coaxially about the bridge 50 by a circlip 64 located towards the second end face 43 of the cam, said circlip locating behind raised annular shoulders of the bridge. In the locked configuration the spring biases the cam in a direction towards the locked configuration from the unlocked configuration of the cam, and with reference to the accompanying drawings, one can see that clockwise, (when looking at the padlock from the shackle end) is the locking direction.

The disc-like stop member 63 has the at least one, and preferably two opposed substantially radially inwardly projecting wedges 65 and 66, (also called herein fingers 65 and 66 respectively), each locating one in each drive recess 48, 49 and an outwardly projecting stop 66A that protrudes into the offset recess. The cam and stop are configured such that when the cam is in the locked configuration, as shown in FIG. 13 to 16, each wedge abuts and a respective first drive shoulder, first drive shoulder 67 of the wall 51 associated with the drive recess 48, first drive shoulder 68 of the wall 52 associated with the drive recess 49, to restrain the cam from rotating in a clockwise direction while the stop itself is restrained from rotating clockwise by the projecting stop that abuts a first wall 69 of the offset recess.

In the locked configuration, each drive pin protrudes longitudinally one into each drive recess to be adjacent the corresponding wedge, and to be engageable with the wedge.

Rotation of the barrel, as shown in FIG. 9 to 12, in an anticlockwise direction from the locked configuration causes each drive pin 57 to engage the adjacent wedge and to urge the stop member 63 and stop portion 66A causing them to rotate in an anticlockwise direction but in so doing each wedge 65 66 simultaneously engages the respective first drive shoulders 67, 68 to cause the cam to rotate in an anticlockwise direction, and in practice the whole cam assembly rotates substantially simultaneously and the same amount in an anticlockwise direction until the stop 66A engages the opposite wall 70 of the offset recess; this latter configuration corresponding to the unlocking position of the cam.

When the cam is in the unlocking or unlocked position and the shackle peripheral recess is engaged with the second ball, the second ball being in the second unlocking recess in the cam prevents the cam from angularly displacing. In the Type 1 padlock the key must then be reversible to the key withdrawal, undisplaced position while the cam remains displaced. To provide this free movement, each drive recess is configured to have free space, (free space 71 within drive recess 48 and free space 72 within drive recess 49) to accommodate this displacement of each pin while the cam remains displaced restrained by the second ball. Referring to FIG. 11, we can see that in the unlocked configuration of the cam, the free space lies between each pin and each respective second stop shoulder of the respective wall 51, 52, said free space enabling the barrel and each drive pin to be rotated to the undisplaced position without causing a drive pin to engage a stop shoulder to urge the cam to rotate.

Preferably, the Type 1 padlock includes a compression spring 18A supported in the longer recess 18 and employed to outwardly bias the longer shackle leg. It has a free length requiring it to be compressed when the shackle is inserted in the casing.

In a Type 2 padlock, when the cam is in the unlocked position and the shackle peripheral recess is engaged with the second ball, the second ball being in the second unlocking recess in the cam prevents the cam from angularly displacing and hence, because of the coupling without free movement between the cam and barrel, the barrel cannot be rotated to the key withdrawal position.

When the cylinder is removed from the padlock by use of the control key or removal of the screw according to which cylinder is employed, the cam may be rotated in an unlocking direction an additional amount and until the release recess 38 aligns with the second ball—this recess being sufficiently deep to allow the second ball to withdraw completely from the longer shackle thereby enabling the shackle to be removed from the body, as shown in FIG. 1 to 4

A hand tool, such as pliers, is used to displace the cam anti-clockwise, (against the action of the spring) in the unlocking direction from the unlocked configuration while the stop member 63 remains undisplaced with the stop portion 66A abutting wall 70. The cam can be so rotated till the stop shoulder 67A, 68A of each wall 51, 52 respectively, engages the corresponding finger 65, 66 respectively to prevent the cam from being further rotated, this cam configuration corresponding to the release configuration of the cam.

Preferably, as shown in FIG. 1 to 4, the release recess is angularly disposed such that the cam is displaced until the end shoulders 67A and 68A engage the wedges 65 and 66 simultaneously to restrain the cam from rotating further in an anti-clockwise direction; shoulders 67A and 68A being the other end shoulders associated with the shoulders 67 and 68 respectively.

Preferably, each of the drive recesses 48 and 49 is formed by advancing a rotating cutter blade having an axis of rotation parallel with that of the cam and which overhangs the drive portion 42 from the second end face 43 towards the first end face. Preferably the annular stop member 63 comprises a metal pressing.

Many variations of the above-described embodiments also come within the scope of the invention, including:

the padlock having a single drive recess, a single drive pin, and a single drive shoulder.

the padlock having a pair of drive recesses, a pair of drive pins, and a pair of drive shoulders,

the cam being without a release recess,

the Type 2 padlock being without a torsion spring, and

the padlock being configured to employ a cylinder of other cross-section

In preferred embodiments, at least one of the shackle recesses comprises a portion or portions of surfaces of revolution in which the axis of revolution defining the surface intersects the body of the shackle and where the surface of the recess extends in all directions from the axis. Preferably the axii of the aforementioned surfaces are parallel and preferably a plane through the axii also intersects the longitudinal axis of the shackle.

The first and second locking recesses preferably comprise a portion or portions of surfaces of revolution as described above. Alternatively, the second locking recess comprises two such portions located adjacently a small distance apart and joined by a channel portion.

The longitudinally elongated recess preferably comprises a channel defined by a uniform cross-section.

Preferably, each of the surfaces of revolution are spherical and are defined by a radius and preferably this radius is substantially the same as the radius of the balls. Preferably the cross-section of the longitudinally elongated channel is defined by a radius and preferably this radius is substantially the same as that of the radius of the balls.

It is envisaged that this improved shackle construction be employed in all types of locks and not just those described herein, including:

a padlock employing only a first locking recess and first ball,

a padlock employing only a second locking recess and second ball,

a padlock where the shackle comprises a cable connected to a solid cylindrical end portion having a first locking recess and the other end is secured to the padlock body,

a padlock where the shackle comprisess a cable connected on one end to a solid cylindrical end portion having a first locking recess and the other end is connected to a solid cylindrical end portion having a second locking recess,

a padlock where the shackle comprises an elongated member having a first locking recess.

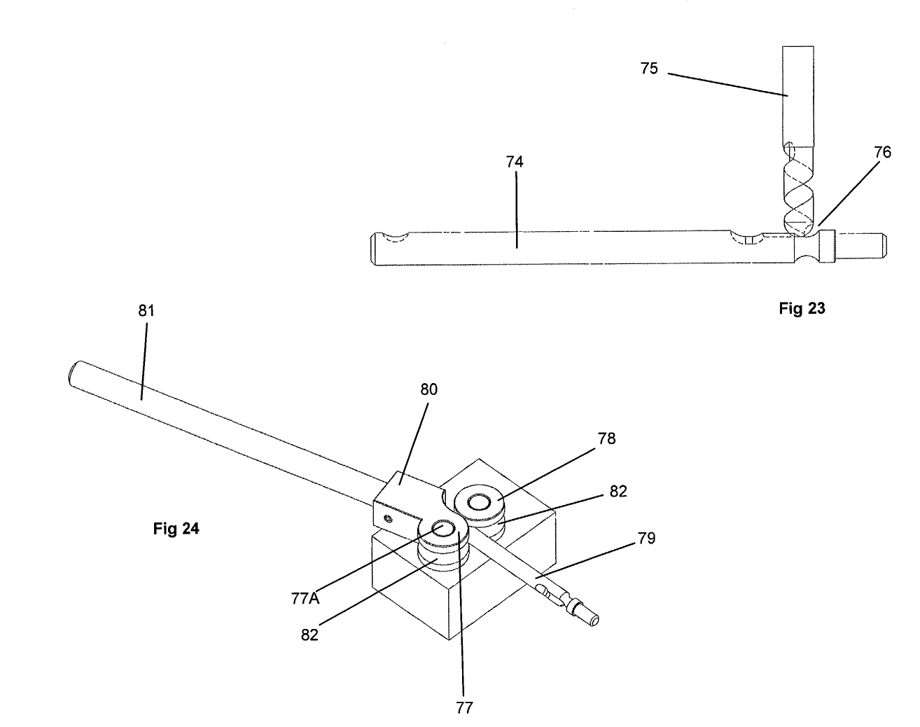

The preferred shackle is manufactured by turning bar on a lathe or similar machine tool to produce a shackle blank 74, as shown in FIG. 23, having chamfered or radiused ends and the peripheral recess. The first and second locking recesses are formed by advancing a rotating cutter tool 75, preferably having a spherical end 76 defined by a radius similar to that of the ball into the shackle blank or partly manufactured shackle, to manufacture a recess having a surface comprising a surface of revolution.

In an alternative embodiment, the second locking recess is constructed firstly by advancing a cutter into the shackle blank as described above and then advancing it a short distance, while it is cutting, longitudinally along the shackle blank.

The longitudinal recess is manufactured by manufacturing the second locking recess and then withdrawing the cutter partly from the formed second locking recess and advancing it, while it is cutting, longitudinally along the shackle blank towards the peripheral recess till the cutter is aligned with peripheral recess. Preferably the cutter tool has a spherical end defined by a radius similar to that of the ball.

Preferably the axis of the cutter tool lies in the same plane as the longitudinal axis of the shackle blank.

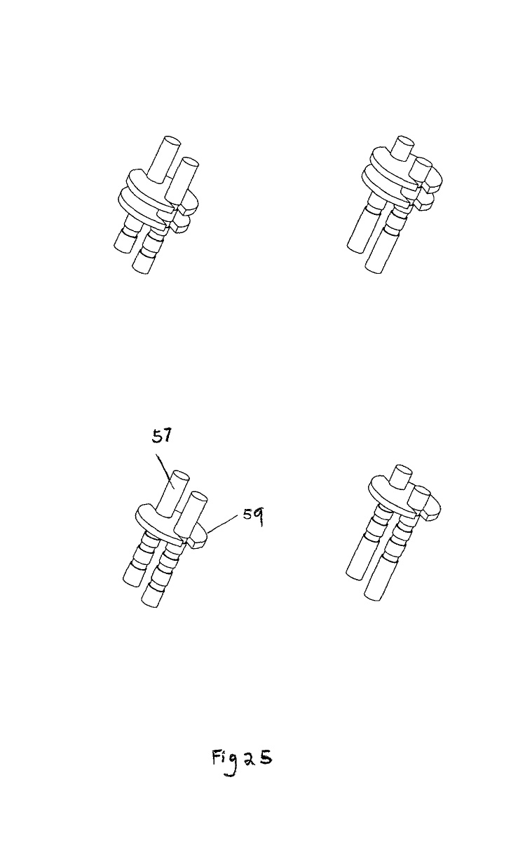

After machining, the shackle blank is aligned so that the plane in which the axii of the surfaces of revolution lie is orthogonal to the axis of an angularly displaceable mandrel 77 about which the shackle will be formed, as shown in FIG. 24—the mandrel being supported on a shaft 77A. The shackle blank 79 is retained adjacent the cylindrical mandrel with the axii pointing towards the mandrel and the junction between the short leg and joining portion touching the side of the mandrel. A roller 78 is located on the other side of the shackle blank so that the shackle blank is between the roller and mandrel and touches both. The mandrel adjacent the shackle blank has a tangential extension comprising a holding block 80 which has an aperture in which to support a leg portion of the shackle and a lever portion 81. The shackle is retained in the aperture by a fastener. Rotation of the lever causes the mandrel and attached block to rotate around the mandrel axis of rotation, while the roller remains fixed but free to rotate, to form the shackle blank in a shape corresponding to the mandrel. In this way the shackle blank is formed to have parallel legs.

Preferably, the short leg which is retained in the block comprising part of the mandrel. Preferably the aperture has a cross recess through which a spherical headed fastener has passage to be displaced firmly into the first locking recess of the shackle blank. Preferably, the surfaces of the roller and cylindrical portion of the mandrel, where they contact the shackle body, comprise recesses having a semi-circular cross-section 82 defined by a radius substantial the same as the radius of the shackle body.

The removable cylinder has a number of transverse pin chambers in the cylinder housing each extending from a portion of the outer surface of the housing to meet coaxially with a pin chamber in the barrel when the key is removed. The longitudinal axii of the chambers are substantially on the same plane when the key is withdrawn. The apertures in the surface where the recesses intersect the surface are plugged to prevent the pins and other components from escaping. Commonly each aperture is plugged with an individual cylindrical plug but preferably the casing between the apertures is connected by a channel which extends to the inner end of the casing and preferably the plug comprises a strip of resilient material such as plastic which occupies the channel and that has substantially cylindrical extensions which extend into each pin chamber. Preferably the extensions are radially compressible and, in-part at least, are of a diameter slightly larger than the chambers so that after being pressed into the chambers they exert a radial force on the walls of the chambers—the chambers in turn exerting a reactionary force on the extensions to retain the extensions within the chambers. When re-pinning is required the strip can be quickly peeled from the cylinder to provide access to the chambers and then quickly re-applied.

This means of capping pin apertures is applicable to all pin cylinders, (not just that described herein), in which the apertures are inaccessible once the cylinder is installed into the padlock or lock in which it is employed.

Throughout this specification and claims that follow, unless the context requires otherwise, the word “comprise”, or variations such as “comprises” or “comprising”, will be understood to imply the inclusion of a stated integer or group of integers but not the exclusion of any other integer or group of integers.

Throughout this specification and claims that follow, unless the context requires otherwise, the positional prepositions such as rear, forward are used to assist in description of the preferred embodiments and have in general no absolute significance.

The claims defining the invention are as follows:

1. A padlock, including a shackle having a short leg with a first locking recess and a longer leg having an opposed second locking recess, said second locking recess being connected by a longitudinally elongated recess or flat to a peripheral recess disposed towards the end of the longer leg,
and a casing having a short and a longer recess extending into the casing from a first end surface to accept the short and longer shackle leg respectively, a central recess extending into the casing from an opposed second end surface, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess,
a cam to control the balls, a coupler between the cam and the barrel to facilitate operable coupling between the cam and the cylinder,
the coupler being configurable to provide a Type 1 padlock characterized by an unlocked, open configuration where short leg is free of the casing, the longer leg is supported in the casing and the key is removable,
the coupler being configurable to provide a Type 2 padlock characterized by an unlocked, open configuration where the short leg is free of the body, the longer leg is supported in the body casing and the key and barrel cannot be rotated to the undisplaced position to enable key removal.

2. A padlock, including a shackle having a short leg with a first locking recess and a longer leg having an opposed second locking recess, said second locking recess being connected by a longitudinally elongated recess or flat to a peripheral recess disposed towards the end of the longer leg,
and a casing having a short and a longer recess extending into the casing from a first end surface to accept the short and longer shackle leg respectively, a central recess extending into the casing from an opposed second end surface, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess
a cam to control the balls,
the angular disposition of the cam in the locking and unlocking configurations being determined by a stop comprising a disc-like member supported coaxially with and relative to the cam, and being angularly displaceable relative to the cam, being displaceable between a first operative configuration and a second operative configuration,
the padlock being characterized by:
a locked configuration corresponding to the stop being in the first operative configuration, and the cam being in a locking configuration retaining the first ball partly within the first locking recess and the second ball being partly within the second locking recess,
the cam and stop member being rotateable in an unlocking direction by the cylinder to displace the padlock to an unlocked configuration, and
an open, unlocked configuration corresponding to the stop being in the second operative configuration, the short leg being free of the casing, the longer leg being supported in the casing, the cam being in an unlocking configuration retaining the second ball partly within the longitudinally elongated recess or flat or partly within the peripheral recess.

3. A padlock, including a shackle having a short leg with a first locking recess and a longer leg having an opposed second locking recess, said second locking recess being connected by a longitudinally elongated recess or flat to a peripheral recess disposed towards the end of the longer leg,
and a casing having a short and a longer recess extending into the casing from a first end surface to accept the short and longer shackle leg respectively, a central recess extending into the casing from an opposed second end surface, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess,
a cam to control the balls, a coupler between the cam and the barrel to facilitate operable coupling between the cam and the cylinder,
the coupler being configurable to provide a Type 1 padlock characterized by an unlocked, open configuration where short leg is free of the casing, the longer leg is supported in the casing and the key is removable,
the coupler being configurable to provide a Type 2 padlock characterized by an unlocked, open configuration where the short leg is free of the body, the longer leg is supported in the body casing and the key and barrel cannot be rotated to the undisplaced position to enable key removal,
wherein the cam includes a first cam portion comprising a substantially cylindrical portion having a curved side surface defined by a longitudinal axis coaxial with the cam axis of rotation and which is parallel with and between the longitudinal axii of the short and longer recess in the casing,
said cam in a locking configuration presenting the curved surface to each ball to retain the balls in the locking recesses,
said cam in the unlocking configuration presenting a first unlocking recess to the first ball and a second unlocking recess to the second ball to enable the first ball to be removed from the first locking recess and the second ball to be displaced from the second locking recess to become partly within the longitudinally elongated recess or the flat or partly within the peripheral recess.

4. A padlock, including a shackle having a short leg with a first locking recess and a longer leg having an opposed second locking recess, said second locking recess being connected by a longitudinally elongated recess or flat to a peripheral recess disposed towards the end of the longer leg,
and a casing having a short and a longer recess extending into the casing from a first end surface to accept the short and longer shackle leg respectively, a central recess extending into the casing from an opposed second end surface, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess
a cam to control the balls,
the angular disposition of the cam in the locking and unlocking configurations being determined by a stop comprising a disc-like member supported coaxially with and relative to the cam, and being angularly displaceable relative to the cam, and being displaceable between a first operative configuration and a second operative configuration,
the padlock being characterized by:
a locked configuration corresponding to the stop being in the first operative configuration, the cam being in a locking configuration retaining the first ball partly within the first locking recess and the second ball being partly within the second locking recess,
the cam and stop member being rotateable in an unlocking direction by the cylinder to displace the padlock to an unlocked configuration, and
an open, unlocked configuration corresponding to the stop being in the second operative configuration, the short leg being free of the casing, the longer leg being supported in the casing and the cam being in an unlocking configuration retaining the second ball partly within the longitudinally elongated recess or flat or partly within the peripheral recess
and wherein the cam includes a first cam portion comprising a substantially cylindrical portion having a curved side surface defined by a longitudinal axis coaxial with the cam axis of rotation and which is parallel with and between the longitudinal axii of the short and longer recess in the casing,
said cam in a locking configuration presenting the curved surface to each ball to retain the balls in the locking recesses,
said cam in the unlocking configuration presenting a first unlocking recess to the first ball and a second unlocking recess to the second ball to enable the first ball to be removed from the first locking recess and the second ball to be displaced from the second locking recess to become partly within the longitudinally elongated recess or the flat or partly within the peripheral recess.

5. A padlock according to claim 3 or 4, wherein the first cam portion is integrally connected to a cam drive portion comprising at least one and preferably two opposed drive recesses, each said drive recess having a floor defined by a plane orthogonal to the axis of rotation of the cam and a side wall, each said drive recess being radially displaced from the cam axis of rotation,
and a bridge portion defined in part by the side wall/walls of each drive recess, each said side wall having a first engageable drive shoulder at one end and a second engageable drive shoulder at the other end, said bridge having opposed peripheral end walls comprising cylindrical portions to support a disc-like stop member which has an aperture of substantially circular cross-section interrupted by one and preferably two fingers according to the number of drive recesses, each said finger inwardly protruding into a separate drive recess to be engageable with a first drive shoulder of the respective side wall and wherein each finger abuts a first drive shoulder when the cam is in the unlocking configuration.

6. A padlock according claim 5, configured as a Type 1 padlock, including a coupler comprising at least one drive pin supported within the cylinder barrel each said drive pin extending into the space between the finger and second drive shoulder to be engageable with the finger, to enable the drive pin to be displaced about the cylinder barrel axis of rotation to displace the first drive shoulder and the interposed finger to the unlocking configuration, and the barrel and key to subsequently be returned to the undisplaced position while the drive pin correspondingly displaces freely within the space between the at least one finger and second drive shoulder.

7. A padlock according to claim 5, configured as a Type 2 padlock, including a coupler comprising at least one drive pin supported within the cylinder barrel each said drive pin extending through the space between the finger and second drive shoulder to protrude into a pin recess within the floor of the drive recess and adjacent the finger, to enable the drive pin to be displaced about the cylinder barrel axis of rotation to displace the first drive shoulder and the interposed finger to the unlocking configuration, the barrel and key being unable to be returned to the undisplaced position because of the direct coupling between the drive pin and cam.

8. A padlock according to claim 6, wherein there is an opposed pair of fingers, an opposed pair of drive shoulders, opposed drive recesses with pin holes and there is correspondingly an opposed pair of drive pins,
said drive pins having passage through while being supported in a support disc to comprise a coupler subassembly, the drive pins being configured to protrude more from one side of the support disc than the other and additionally being configured so that when assembled into the padlock body with the shorter ends towards the cam, they protrude into drive recesses but not into the pin holes.

9. A padlock according to claim 7, wherein there is an opposed pair of fingers, an opposed pair of drive shoulders, opposed drive recesses with pin holes and there is correspondingly an opposed pair of drive pins,
said drive pins having passage through while being supported in a support disc to comprise a coupler subassembly, the drive pins being configured to protrude more from one side of the support disc than the other and additionally being configured so that when assembled into the padlock body with the longer ends towards the cam, they protrude into the pin holes.

10. A padlock according to claim 5, wherein the cam has a removal configuration enabling the removal of the shackle, the cam in the removal configuration presenting a third side recess, deeper than the second recess, to the second ball to enable the second ball to be removed from all the recesses of the longer leg,
and wherein the cam is rotatable in the unlocking direction to the removal configuration while the stop remains in the second operative configuration, said removal configuration corresponding to the short leg being free of the casing.

11. A padlock according to claim 10, wherein each finger in the removal configuration of the cam abuts an associated second drive shoulder.

12. A padlock according to claim 5, including a torsion spring supported about the bridge having one end attached to the cam and the other attached relative to the casing to bias the cam towards the locking configuration.

13. A padlock according to any one of claims 1 to 4, including a compression spring within the longer recess to bias the shackle from the body.

14. A padlock according to any one of claims 1 to 4, wherein the cylinder is removable to provide accessibility to the cam to enable it to be rotated to the removal configuration while the stop remains undisplaced in the second operative position.

15. A padlock according to any one of claims 1 to 4, wherein the cylinder is retained in the casing by a threaded fastener having a head accessible through the short recess, said cylinder barrel being free to rotate without limitation when the cylinder is removed from the casing.

16. A padlock according to any one of claims 1 to 4, wherein the cylinder comprises an interchangeable core retained in the casing by a sideways protruding shoulder that is displaceable to withdraw into the core by the application of a control key, said cylinder barrel being free to rotate without limitation when the cylinder is removed from the casing.

17. A padlock according to any one of claims 1 to 4, wherein the cylinder comprising a pin cylinder having a casing with pin chambers extending from the surface of the casing, and wherein adjacent chambers adjacent the surface of the casing are joined by a channel, said channel accommodating a resilient elongated strip extending between the chambers and having substantially cylindrical portions extending one into each chamber.

18. A padlock according to any one of claims 1 to 4 and substantially as described herein with reference to and as illustrated in the accompanying drawings.

19. A padlock shackle having at least one locking recess having a surface comprising a portion or portions of surfaces of revolution in which the axis of revolution defining the surface intersects the body of the leg and where the surface of the recess extends in all directions from the axis.

20. A padlock shackle having at least one locking recess having a surface comprising a portion or portions of surfaces of revolution in which the axis of revolution defining the surface intersects the body of the leg and where the surface of the recess extends in all directions from the axis, including a locking recess comprising two such portions located adjacently and a small distance from an other recess each being joined by a channel portion.

21. A padlock shackle having at least one locking recess having a surface comprising a portion or portions of surfaces of revolution in which the axis of revolution defining the surface intersects the body of the leg and where the surface of the recess extends in all directions from the axis, wherein the padlock shackle is defined by two parallel co-planar legs; a short leg having a first locking recess and a longer leg having a second locking, substantially opposed, recess; the second locking recess being connected by a longitudinally elongated recess to a peripheral recess disposed towards the end of the longer leg,
the surface of the first and second locking recesses being substantially comprised of a portion or portions of surfaces of revolution, each said portion having an axis of revolution which intersects the shackle body to provide a surface portion extending on all sides from the axis of revolution.

22. A padlock shackle having at least one locking recess having a surface comprising a portion or portions of surfaces of revolution in which the axis of revolution defining the surface intersects the body of the leg and where the surface of the recess extends in all directions from the axis, including a locking recess comprising two such portions located adjacently and a small distance from an other recess each being joined by a channel portion, wherein the padlock shackle is defined by two parallel co-planar legs; a short leg having a first locking recess and a longer leg having a second locking, substantially opposed, recess; the second locking recess being connected by a longitudinally elongated recess to a peripheral recess disposed towards the end of the longer leg,
the surface of the first and second locking recesses being substantially comprised of a portion or portions of surfaces of revolution, each said portion having an axis of revolution which intersects the shackle body to provide a surface portion extending on all sides from the axis of revolution.

23. A padlock shackle according to claim 21 or 22, wherein the longitudinally elongated recess comprises a longitudinal channel.

24. A padlock shackle according to claim 21 or 22, wherein the peripheral recess comprises a peripheral channel around the periphery of the shackle body.

25. A padlock shackle according to any one of claims 19 to 22, wherein the portions of surfaces of revolution and comprise spherical portions defined by a radius substantially the same as the radii of the balls.

26. A padlock shackle according to claim 23, wherein the channel cross-section is defined by a radius substantially the same as the radii of the balls.

27. A padlock shackle according to claim 24, wherein the channel cross-section is defined by a radius substantially the same as the radii of the balls.

28. A padlock shackle according to any one of claims 19 to 22 and substantially as described herein with reference to and as illustrated in the accompanying drawings.

29. A padlock according to any one of claims 1 to 4 which includes a shackle selected from the group consisting of:
(i) a padlock shackle having at least one locking recess having a surface comprising a portion or portions of surfaces of revolution in which the axis of revolution defining the surface intersects the body of the leg and where the surface of the recess extends in all directions from the axis;
(ii) a padlock shackle having at least one locking recess having a surface comprising a portion or portions of surfaces of revolution in which the axis of revolution defining the surface intersects the body of the leg and where the surface of the recess extends in all directions from the axis, including a locking recess comprising two such portions located adjacently and a small distance from an other recess each being joined by a channel portion;
(iii) a padlock shackle having at least one locking recess having a surface comprising a portion or portions of surfaces of revolution in which the axis of revolution defining the surface intersects the body of the leg and where the surface of the recess extends in all directions from the axis, wherein the padlock shackle is defined by two parallel co-planar legs; a short leg having a first locking recess and a longer leg having a second locking, substantially opposed, recess; the second locking recess being connected by a longitudinally elongated recess to a peripheral recess disposed towards the end of the longer leg,
the surface of the first and second locking recesses being substantially comprised of a portion or portions of surfaces of revolution, each said portion having an axis of revolution which intersects the shackle body to provide a surface portion extending on all sides from the axis of revolution; and
(iv) a padlock shackle having at least one locking recess having a surface comprising a portion or portions of surfaces of revolution in which the axis of revolution defining the surface intersects the body of the leg and where the surface of the recess extends in all directions from the axis, including a locking recess comprising two such portions located adjacently and a small distance from an other recess each being joined by a channel portion, wherein the padlock shackle is defined by two parallel co-planar legs; a short leg having a first locking recess and a longer leg having a second locking, substantially opposed, recess; the second locking recess being connected by a longitudinally elongated recess to a peripheral recess disposed towards the end of the longer leg,
the surface of the first and second locking recesses being substantially comprised of a portion or portions of surfaces of revolution, each said portion having an axis of revolution which intersects the shackle body to provide a surface portion extending on all sides from the axis of revolution.

30. A method of manufacture of a padlock shackle according to any one of claims 19 to 22, including the step of advancing a rotating cutter blade into the side of an unformed shackle blank to manufacture a recess.

31. A method of manufacture of a padlock shackle according to any one of claims 19 to 22, including the steps of;
(1) advancing a rotating cutter blade into the side of an unformed shackle blank to manufacture a recess, and
(2) advancing the rotating cutter blade longitudinally along the shackle body to manufacture a channel.

32. A method of manufacture for a padlock shackle according to claim 31, including the further steps of;
(3) manufacturing a first and then a second locking recess by advancing a rotating cutter blade into the side of an unformed shackle blank,
(4) partly withdrawing the cutter from the second locking recess, and
(5) advancing it longitudinally along the shackle blank to manufacture a channel,
wherein said longitudinal channel connects to a pre-manufactured peripheral recess

33. A method of manufacture for a padlock shackle according to claim 32, including the further steps of;
(6) aligning the shackle blank so that the plane in which the axii of the spherical portions lie is orthogonal to the longitudinal axis of a mandrel,
(7) fixing a leg portion of the shackle blank within an elongated recess in a substantially tangential extension to the mandrel which includes an operating lever such that a reference portion of the shackle blank is retained adjacent to a cylindrical portion of the mandrel with the recesses disposed generally towards the mandrel, said reference portion comprising the junction between a leg and joining portion,
(8) positioning a roller adjacent the reference portion so that the shackle blank extends tangentially in relation to and from between the mandrel and roller,
(9) rotating the mandrel while maintaining the roller undisplaced to form the shackle blank into a shape corresponding to the mandrel to form the shackle body portion which joins the short and longer legs and to align the legs so that the longitudinal axii of the legs are substantially parallel.

34. A method of manufacture for a padlock shackle according to claim 33, wherein the surfaces of the roller and cylindrical portion of the mandrel, where they contact the shackle blank, comprise annular recesses having a semi-circular cross-section defined by a radius substantial the same as the radius of the shackle body.

35. A method of manufacture for a padlock shackle according to claim 31, wherein the axis of the cutter is within a plane that intersects the longitudinal axis of the shackle blank.

36. A method of manufacture for a padlock shackle according to claim 34, wherein the axis of the cutter is within a plane that intersects the longitudinal axis of the shackle blank.

37. A padlock, including a shackle as claimed in any one of claims 19 to 22 having a short leg with a first locking recess and a longer leg having an opposed second locking recess, said second locking recess being connected by a longitudinally elongated recess or flat to a peripheral recess disposed towards the end of the longer leg, and
a casing having a short and a longer recess extending into the casing from a first end surface to accept the short and longer shackle leg respectively, a central recess extending into the casing from an opposed second end surface, the intersection defining a first and a second longitudinally elongated cusp portions, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess,
a cam to control the balls, and a coupler between the cam and barrel to facilitate operable coupling between the cam and the cylinder,
the coupler being configurable to provide a Type 1 padlock characterized by an unlocked, open configuration where short leg is free of the casing, the longer leg is supported in the casing and the key is removable,
the coupler being configurable to provide a Type 2 padlock characterized by an unlocked, open configuration where the short leg is free of the body, the longer leg is supported in the body casing and the key and barrel cannot be rotated to the undisplaced position to enable key removal,
wherein the cam includes a first cam portion comprising a substantially cylindrical portion having a curved side surface defined by a longitudinal axis coaxial with the cam axis of rotation and which is parallel with and between the longitudinal axii of the short and longer recess in the casing,
the cam having a removal configuration enabling the removal of the shackle, the cam in the removal configuration presenting a third side recess, deeper than the second recess, to the second ball to enable the second ball to be removed from all the recesses of the longer leg,
wherein the cam is rotatable in the unlocking direction to the removal configuration while the stop remains in the second operative configuration,
said removal configuration corresponding to the short leg being free of the casing.
said cam in a locking configuration presenting the curved surface to each ball to retain the balls in the locking recesses,
said cam in the unlocking configuration presenting a first unlocking recess to the first ball and a second unlocking recess to the second ball to enable the first ball to be removed from the first locking recess and the second ball to be displaced from the second locking recess to become partly within the longitudinally elongated recess or the flat or partly within the peripheral recess.

38. A padlock, including a shackle as claimed in any one of claims 19 to 22 having a short leg with a first locking recess and a longer leg having an opposed second locking recess, said second locking recess being connected by a longitudinally elongated recess or flat to a peripheral recess disposed towards the end of the longer leg, and
a casing having a short and a longer recess extending into the casing from a first end surface to accept the short and longer shackle leg respectively, a central recess extending into the casing from an opposed second end surface, an offset recess extending into the casing from the opposed second end surface and intersecting the central recess, the intersection defining a first and a second-longitudinally elongated cusp portion, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess
a cam to control the balls,
the angular disposition of the cam in the locking and unlocking configurations being determined by a stop comprising a disc-like member supported coaxially with and relative to the cam, and being angularly displaceable relative to the cam, and having a stop shoulder which protrudes into the offset recess, said stop having a first operative configuration where the stop shoulder abuts the wall of the offset recess adjacent the first cusp and a second operative configuration where the stop shoulder abuts the opposite wall of the offset casing adjacent second cusp,
the padlock being characterized by:
a closed, locked configuration corresponding to the stop being in the first operative configuration, the short and longer legs being supported in the casing and restrained from displacing relative to the casing, the cam being in a locking configuration and retaining the first ball partly within the first locking recess and the second ball being partly within the second locking recess,
the cam and stop member being rotateable in an unlocking direction by the cylinder to displace the padlock to an unlocked configuration, and
an open, unlocked configuration corresponding to the stop being in the second operative configuration, the short leg being free of the casing, the longer leg being supported in the casing, the cam being in an unlocking configuration and retaining the second ball partly within the longitudinally elongated recess or flat-or partly within the peripheral recess and,
wherein the cam includes a first cam portion comprising a substantially cylindrical portion having a curved side surface defined by a longitudinal axis coaxial with the cam axis of rotation and which is parallel with and between the longitudinal axii of the short and longer recess in the casing,
the cam portion having a removal configuration enabling the removal of the shackle, the cam in the removal configuration presenting a third side recess, deeper than the second recess, to the second ball to enable the second ball to be removed from all the recesses of the longer leg, and
wherein the cam is rotatable in the unlocking direction to the removal configuration while the stop remains in the second operative configuration,
said removal configuration corresponding to the short leg being free of the casing,
said cam in a locking configuration presenting the curved surface to each ball to retain the balls in the locking recesses,
said cam in the unlocking configuration presenting a first unlocking recess to the first ball and a second unlocking recess to the second ball to enable the first ball to be removed from the first locking recess and the second ball to be displaced from the second locking recess to become partly within the longitudinally elongated recess or the flat or partly within the peripheral recess.

39. A padlock, including a shackle having a short leg with a first locking recess and a longer leg having an opposed second locking recess, said second locking recess being connected by a longitudinally elongated recess or flat to a peripheral recess disposed towards the end of the longer leg, the shackle also having at least one locking recess having a surface comprising a portion or portions of surfaces of revolution in which the axis of revolution defining the surface intersects the body of the leg and where the surface of the recess extends in all directions from the axis, and
a casing having a short and a longer recess extending into the casing from a first end surface to accept the short and longer shackle leg respectively, a central recess extending into the casing from an opposed second end surface, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess,
a cam to control the balls, and a coupler between the cam and barrel to facilitate operable coupling between the cam and the cylinder,
the coupler being configurable to provide a Type 1 padlock characterized by an unlocked, open configuration where short leg is free of the casing, the longer leg is supported in the casing and the key is removable,
the coupler being configurable to provide a Type 2 padlock characterized by an unlocked, open configuration where the short leg is free of the body, the longer leg is supported in the body casing and the key and barrel cannot be rotated to the undisplaced position to enable key removal,
wherein the cam includes a first cam portion comprising wherein the cam includes a first cam portion comprising a substantially cylindrical portion having a curved side surface defined by a longitudinal axis coaxial with the cam axis of rotation-and which is parallel with and between the longitudinal axii of the short and longer recess in the casing, and wherein the first cam portion is integrally connected to a cam drive portion relatively disposed towards the casing second end surface, and
wherein the first cam portion is integrally connected to a cam drive portion comprising at least one and preferably two opposed drive recesses, each said drive recess having a floor defined by a plane orthogonal to the axis of rotation of the cam and a side wall, each said drive recess being radially displaced from the cam axis of rotation,
and a bridge portion defined in part by the side wall/walls of each drive recess, each said side wall having a first engageable drive shoulder at one end and a second engageable drive shoulder at the other end, said bridge having opposed peripheral end walls comprising cylindrical portions to support a disc-like stop member which has an aperture of substantially circular cross-section interrupted by one and preferably two fingers according to the number of drive recesses, each said finger inwardly protruding into a separate drive recess to be engageable with a first drive shoulder of the respective side wall and wherein each finger abuts a first drive shoulder when the cam is in the unlocking configuration.
said cam in a locking configuration presenting the curved surface to each ball to retain the balls in the locking recesses,
said cam in the unlocking configuration presenting a first unlocking recess to the first ball and a second unlocking recess to the second ball to enable the first ball to be removed from the first locking recess and the second ball to be displaced from the second locking recess to become partly within the longitudinally elongated recess or the flat or partly within the peripheral recess.
wherein the fist cam portion has a removal configuration enabling the removal of the shackle, the cam in the removal configuration presenting a third side recess, deeper than the second recess, to the second ball to enable the second ball to be removed from all the recesses of the longer leg
and wherein the cam is rotatable in the unlocking direction to the removal configuration while the stop remains in the second operative configuration,
said removal configuration corresponding to the short leg being free of the casing.

40. A padlock, including a shackle having a short leg with a first locking recess and a longer leg having an opposed second locking recess, said second locking recess being connected by a longitudinally elongated recess to a peripheral recess disposed towards the end of the longer leg, the shackle also having at least one locking recess having a surface comprising a portion or portions of surfaces of revolution in which the axis of revolution defining the surface intersects the body of the leg and where the surface of the recess extends in all directions from the axis,
and a casing having a short and a longer recess extending into the casing from a first end surface to accept the short and longer shackle leg respectively, a central recess extending into the casing from an opposed second end surface, an offset recess extending into the casing from the opposed second end surface and intersecting the central recess, the intersection defining a first and a second longitudinally elongated cusp portion, said short, longer and central recesses being intersected by a transverse recess extending into the casing from a first side of the casing,
a cylinder having a key operable barrel characterized by an undisplaced position enabling key removal,
two opposed balls supported within the transverse recess; a first ball able to protrude into the short recess and first locking recess and a second ball to protrude into the longer recess and second locking recess
a cam to control the balls,
the angular disposition of the cam in the locking and unlocking configurations being determined by a stop comprising a disc-like member supported coaxially with and relative to the cam, and being angularly displaceable relative to the cam, and having a stop shoulder which protrudes into the offset recess, said stop having a first operative configuration where the stop shoulder abuts the wall of the offset recess adjacent the first cusp and a second operative configuration where the stop shoulder abuts the opposite wall of the offset casing adjacent second cusp,
the padlock being characterized by a closed, locked configuration corresponding to the stop being in the first operative configuration, the short and longer legs being supported in the casing and restrained from displacing relative to the casing, the cam being in a locking configuration and retaining the first ball partly within the first locking recess and the second ball being partly within the second locking recess,
the cam and stop member being rotatable in an unlocking direction by the cylinder to displace the padlock to an unlocked configuration, and
an open, unlocked configuration corresponding to the stop being in the second operative configuration, the short leg being free of the casing, the longer leg being supported in the casing, the cam being in an unlocking configuration and retaining the second ball partly within the longitudinally elongated recess or partly within the peripheral recess, and
wherein the cam includes a first cam portion comprising a substantially cylindrical portion having a curved side surface defined by a longitudinal axis coaxial with the cam axis of rotation and which is parallel with and between the longitudinal axii of the short and longer recess in the casing, and wherein the first cam portion has a removal configuration enabling the removal of the shackle,
said cam in a locking configuration presenting the curved surface to each ball to retain the balls in the locking recesses,
said cam in the unlocking configuration presenting a first unlocking recess to the first ball and a second unlocking recess to the second ball to enable the first ball to be removed from the first locking recess and the second ball to be displaced from the second locking recess to become partly within the longitudinally elongated recess or the flat or partly within the peripheral recess, and
wherein the cam in the removal configuration presents a third side recess, deeper than the second recess, to the second ball to enable the second ball to be removed from all the recesses of the longer leg, and
wherein the cam is rotatable in the unlocking direction to the removal configuration while the stop remains in the second operative configuration,
said removal configuration corresponding to the short leg being free of the casing.

41. A padlock shackle having at least one locking recess having a surface comprising a portion or portions of surfaces of revolution in which the axis of revolution defining the surface intersects the body of the leg and where the surface of the recess extends in all directions from the axis, including a locking recess comprising two such portions located adjacently and a small distance from an other recess each being joined by a channel portion, wherein the padlock shackle is defined by two parallel co-planar legs; a short leg having a first locking recess and a longer leg having a second locking, substantially opposed, recess; the second locking recess being connected by a longitudinally elongated channel to a peripheral channel around the periphery of the shackle body, disposed towards the end of the longer leg, the channel cross-section being defined by a radius substantially the same as the radii of the balls the surface of the first and second locking recesses being substantially comprised of a portion or portions of surfaces of revolution, each said portion having an axis of revolution which intersects the shackle body to provide a surface portion extending on all sides from the axis of revolution, wherein the portions of surfaces of revolution comprise spherical portions defined by a radius substantially the same as the radii of the balls.
